(19) United States
(12) Patent Application Publication
(10) Pub. No.: US 2024/0226751 A1
(43) Pub. Date: Jul. 11, 2024

(54) DATA PROCESSING APPARATUS AND METHOD

(71) Applicant: Sony Interactive Entertainment Inc., Tokyo (JP)

(72) Inventors: Calum Armstrong, London (GB); Navin Kamath, London (GB); Ross Maw, London (GB); Maria Chiara Monti, London (GB)

(73) Assignee: Sony Interactive Entertainment Inc., Tokyo (JP)

(21) Appl. No.: 18/406,292

(22) Filed: Jan. 8, 2024

(30) Foreign Application Priority Data
Jan. 10, 2023 (GB) 2300326.2

(51) Int. Cl. A63F 13/67; A63F 13/63; A63F 13/79

(52) U.S. Cl. CPC A63F 13/67; A63F 13/63; A63F 13/79

(57) ABSTRACT

A data processing apparatus includes circuitry configured to: store information indicative of a general difficulty rating associated with each of one or more general gaming characteristics applicable to a plurality of video games; provide access to the stored information to an application of a first video game to enable a specific difficulty rating associated with a specific gaming characteristic applicable to the first video game to be determined based on each general difficulty rating; and provide access to the stored information to an application of a second video game to enable a specific difficulty rating associated with a specific gaming characteristic applicable to the second video game to be determined based on each general difficulty rating.

### BACKGROUND

### Field of the Disclosure

This disclosure relates to a data processing apparatus and method.

### Description of the Related Art

The “background” description provided is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present disclosure.

Video games are often played by a variety of different users with different levels of skill at the game. To improve the user experience, it is known to allow the difficulty of a game to be adjusted by a user. For example, a game may have an “easy”, “medium” and “hard” setting chosen by the user in advance. This affects applicable elements of the game play. For example, in a car racing game, the difficulty mode may affect how easy it is to control the car, the performance of artificial intelligence (AI) competitors in controlling their cars, etc. In a first person shooter game, the difficulty mode may affect how easy it is to accurately shoot at enemies, the skill of AI enemies in shooting back and avoiding being shot, etc.

However, controlling the difficulty level of a video game in this way is relatively inflexible. For example, some users may wish certain aspects of the game to be made easier while allowing other aspects of the game to be more challenging. A general “easy” mode may not be suitable because it will make all aspects of the game easier (including the aspect of the game the user wishes to be more challenging). Furthermore, a “hard” mode may also not be suitable because it will make all aspects of the game harder (including the aspect of the game the user wishes to be easier).

This may be particularly applicable to users with accessibility needs. For instance, a user with finger dexterity restrictions may want a game to be cognitively challenging but not to require fast controller reactions. As another example, a user who is hard of hearing may wish for audio cues to be simplified but for visual cues to remain subtle and challenging. It is difficult to achieve this with current general difficulty levels (e.g. “easy”, “medium” and “hard”).

A related problem is that, because every user is different, a mode classed as “easy” or “hard” may not give a consistent “easy” or “hard” gaming experience to different users. For instance, a user with a lot of experience with a particular type of game (e.g. first person shooters) may be less likely to find the “hard” mode of such a game as difficult as a user with less experience of that particular game type. Each user thus has to spend time, on each individual game, manually finding the difficulty mode which best matches their ability in playing the game. This can be cumbersome and time consuming.

There is therefore a desire for a technical solution for allowing more convenient and more personalised adjustment of difficulty in video games.

### SUMMARY

The present disclosure is defined by the claims.

### BRIEF DESCRIPTION OF THE DRAWINGS

Non-limiting embodiments and advantages of the present disclosure are explained with reference to the following detailed description taken in conjunction with the accompanying drawings, wherein:

FIG. 1 schematically shows an example entertainment system;

FIGS. 2A and 2B schematically show example components associated with the entertainment system;

FIG. 3 schematically shows an example interactive global difficulty profile selection screen;

FIG. 4 schematically shows an example data structure;

FIG. 5 schematically shows an example technique for determining gaming ability characteristic(s) of a user.

FIG. 6 schematically shows an example lookup table for a racing game;

FIG. 7 schematically shows an example lookup table for a first person shooter game;

FIG. 8 shows a first example method/process; and

FIG. 9 shows a second example method/process.

Like reference numerals designate identical or corresponding parts throughout the drawings.

### DETAILED DESCRIPTION OF THE EMBODIMENTS

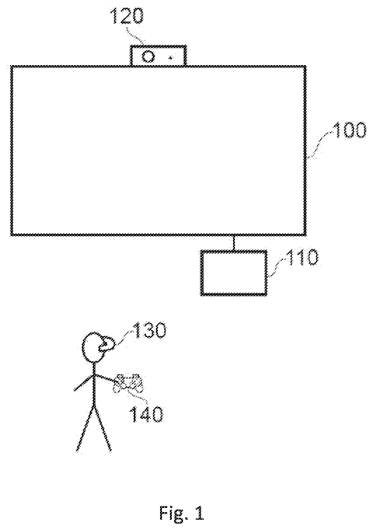

FIG. 1 schematically illustrates an entertainment system suitable for implementing one or more of the embodiments of the present disclosure. Any suitable combination of devices and peripherals may be used to implement embodiments of the present disclosure, rather than being limited only to the configuration shown.

A display device 100 (e.g. a television or monitor), associated with a games console 110, is used to display content to one or more users. A user is someone who interacts with the displayed content, such as a player of a game, or, at least, someone who views the displayed content. A user who views the displayed content without interacting with it may be referred to as a viewer. This content may be a video game, for example, or any other content such as a movie or any other video content. The games console 110 is an example of a content providing device or entertainment device; alternative, or additional, devices may include computers, mobile phones, set-top boxes, and physical media playback devices, for example. In some embodiments the content may be obtained by the display device itself—for instance, via a network connection or a local hard drive.

One or more video and/or audio capture devices (such as the integrated camera and microphone 120) may be provided to capture images and/or audio in the environment of the display device. While shown as a separate unit in FIG. 1, it is considered that such devices may be integrated within one or more other units (such as the display device 100 or the games console 110 in FIG. 1).

In some implementations, an additional or alternative display device such as a head-mountable display (HMD) 130 may be provided. Such a display can be worn on the head of a user, and is operable to provide augmented reality or virtual reality content to a user via a near-eye display screen. A user may be further provided with a video game controller 140 which enables the user to interact with the games console 110. This may be through the provision of buttons, motion sensors, cameras, microphones, and/or any other suitable method of detecting an input from or action by a user.

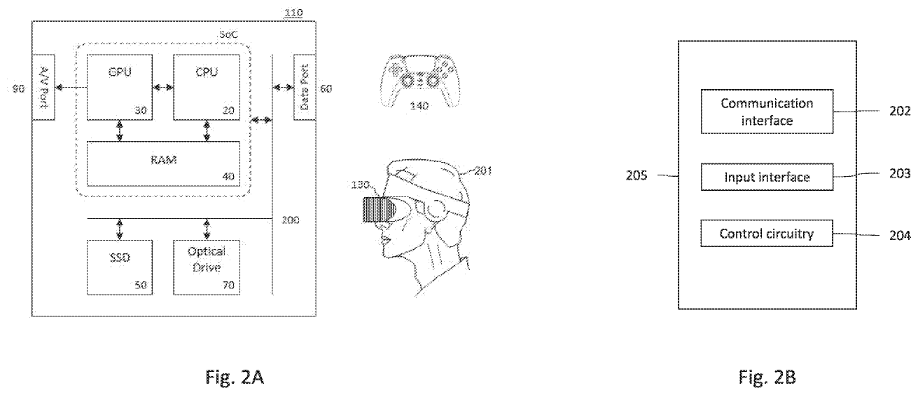

FIG. 2A shows an example of the games console 110. An example is the Sony® PlayStation 5® (PS5). The games console 110 is an example of a data processing apparatus.

The games console 110 comprises a central processing unit or CPU 20. This may be a single or multi core processor, for example comprising eight cores as in the PS5. The games console also comprises a graphical processing unit or GPU 30. The GPU can be physically separate to the CPU, or integrated with the CPU as a system on a chip (SoC) as in the PS5.

The games console also comprises random access memory, RAM 40, and may either have separate RAM for each of the CPU and GPU, or shared RAM as in the PS5. The or each RAM can be physically separate, or integrated as part of an SoC as in the PS5. Further storage is provided by a disk 50, either as an external or internal hard drive, or as an external solid state drive (SSD), or an internal SSD as in the PS5.

The games console may transmit or receive data via one or more data ports 60, such as a universal serial bus (USB) port, Ethernet® port, WiFi® port, Bluetooth® port or similar, as appropriate. It may also optionally receive data via an optical drive 70.

Interaction with the games console is typically provided using one or more instances of the controller 140, such as the DualSense® handheld controller in the case of the PS5. In an example, communication between each controller 140 and the games console 110 occurs via the data port(s) 60.

Audio/visual (A/V) outputs from the games console are typically provided through one or more A/V ports 90, or through one or more of the wired or wireless data ports 60. The A/V port(s) 90 may also receive audio/visual signals output by the integrated camera and microphone 120, for example. The microphone is optional and/or may be separate to the camera. Thus, the integrated camera and microphone 120 may instead be a camera only. The camera may capture still and/or video images.

Where components are not integrated, they may be connected as appropriate either by a dedicated data link or via a bus 200.

As explained, examples of a device for displaying images output by the game console 110 are the display device 100 and the HMD 130. The HMD is worn by a user 201. In an example, communication between the display device 100 and the games console 110 occurs via the A/V port(s) 90 and communication between the HMD 130 and the games console 110 occurs via the data port(s) 60.

The controller 140 is an example of a peripheral device for allowing the games console 110 to receive input from and/or provide output to the user. Examples of other peripheral devices include wearable devices (such as smartwatches, fitness trackers and the like), microphones (for receiving speech input from the user) and headphones (for outputting audible sounds to the user).

FIG. 2B shows some example components of a peripheral device 205 for receiving input from a user. The peripheral device comprises a communication interface 202 for transmitting wireless signals to and/or receiving wireless signals from the games console 110 (e.g. via data port(s) 60) and an input interface 203 for receiving input from the user. The communication interface 202 and input interface 203 are controlled by control circuitry 204.

When the peripheral device 205 is the controller 140, the input interface 203 comprises the button(s), motion sensor(s), camera(s), microphone(s) and/or any other component(s) of the controller 140 for detecting an input from or action by a user. In another example, if the peripheral device 205 is a microphone, the input interface 203 comprises a transducer for detecting speech uttered by a user as an input. In another example, if the peripheral device 205 is a fitness tracker, the input interface 203 comprises a photoplethysmogram (PPG) sensor for detecting a heart rate of the user as an input. The input interface 203 may take any other suitable form depending on the type of input the peripheral device is configured to detect.

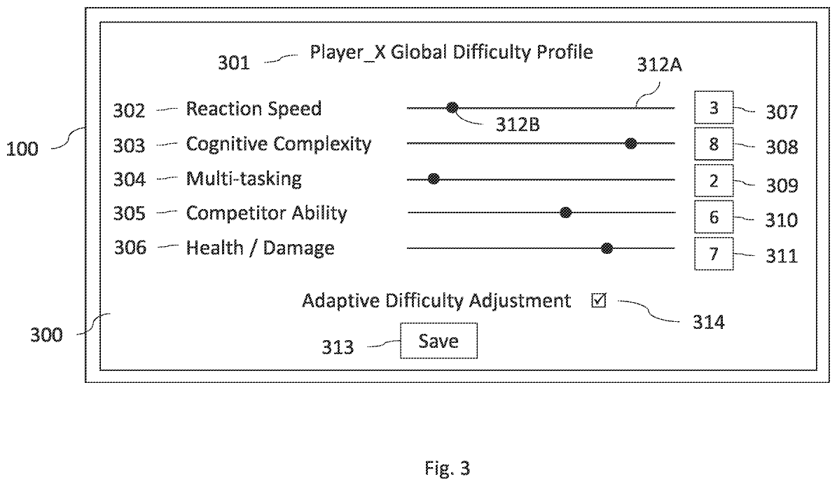

FIG. 3 shows an example interactive global difficulty profile selection screen 300 according to an example of the present technique. For example, the games console 110 causes the display device 100 to display the screen 300 in response to the selection of an appropriate option by the user (e.g. using controller 140) via a settings menu or the like of the games console 110.

The screen 300 allows a user to select a difficulty level associated with each of one or more gaming characteristics. Each of these gaming characteristics is generalised to be applicable to a plurality of different games and/or game types.

In this example, the gaming characteristics include “Reaction Speed” 302, “Cognitive Complexity” 303, “Multi-tasking” 304, “Competitor Ability” 305 and “Health/Damage” 306.

Each gaming characteristic is associated with a respective virtual slider 312B on a virtual slide track 312A, which is positioned on the screen 300 next to that gaming characteristic. A user is able to interact with the virtual slider 312B (e.g. using controller 140) associated with a particular gaming characteristic to adjust a difficulty level associated with gaming characteristic. In this example, the moving the slider 312B to the left reduces the difficulty level (that is, makes the difficulty level easier) whereas moving the slider 312B to the right increases the difficulty level (that is, makes the difficulty level more difficult).

In this example, a numerical indication of the difficulty level (difficulty rating) is also indicated next to the relevant virtual slide track 312A. In this example, the difficulty rating may be adjusted between 1 and 10 (e.g. in integer steps), with 1 indicating the easiest difficulty level and 10 indicating the hardest (that is, most difficult) difficulty level. As the slider 312B is moved to the left for a given gaming characteristic, the difficulty level for that gaming characteristic is reduced and the difficulty rating is reduced accordingly. On the other hand, as the slider 312B is moved to the right, the difficulty level is increased and the difficulty rating is increased accordingly.

In this example, the difficulty rating for “Reaction Speed” is “3”, the difficulty rating for “Cognitive Complexity” is “8”, the difficulty rating for “Multi-tasking” is “2”, the difficulty rating for “Competitor Ability” is “6” and the difficult rating “Health/Damage” is “7”.

As will be explained, the difficulty rating of each of the gaming characteristics is convertible to one or more game-specific difficulty-related parameters. However, generally speaking, each of the gaming characteristics may be described as follows.

“Reaction Speed” relates to the reaction speed required by a user in responding to stimuli in the game (for example, how quickly a user must be able to respond to a sudden attack by an enemy in a game by pressing appropriate buttons on the controller 140 in order to survive the attack). A slower required reaction speed may generally be considered as easier and a faster required reaction speed may generally be considered as harder.

“Cognitive Complexity” relates to the complexity of problems a user must solve in the game (for example, what steps a user must take to find a way out of a locked room in a game). Less complex problems may generally be considered as easier and more complex problems may generally be considered as harder.

“Multi-tasking” relates to the number of tasks a user must perform simultaneously during the game. For example, this may relate to how many input operations a user must simultaneously perform using the controller 140 and/or how many challenges a user must simultaneously face (e.g. coming under enemy fire while moving around obstacles and/or while avoiding falling from a building). The need to perform fewer simultaneous tasks may generally be considered as easier and the need to perform more simultaneous tasks may generally be considered as harder.

“Competitor Ability” relates to the ability of competitors in the game. This may include AI competitors and human competitors (e.g. other users who play against the user over a network). For AI competitors, for example, this may relate to parameters (e.g. speed, shot accuracy or the like) used for controlling the AI competitors. For human competitors, for example, this may relate to choosing human competitors who have previously reached an appropriate level in a game and/or obtained appropriate other in-game achievements. The presence of lower ability competitors (whether AI or human) may generally be considered as easier and the presence of higher ability competitors may generally be considered as harder.

“Health/Damage” relates to the capacity of an in-game character or object controlled by a user to sustain injury or damage (for example, by a character suffering an enemy attack or a vehicle controlled by a user suffering damage due to a collision). A higher capacity to sustain injury or damage (e.g. before a user's character dies or a user's vehicle no longer functions) may generally be considered as easier and a lower capacity to sustain injury or damage may generally be considered as harder.

The present technique thus allows a user to adjust the difficulty associated with individual gaming characteristics depending on the specific needs or desires of that user.

For example, the difficulty ratings of FIG. 3, which are higher for “Cognitive Complexity”, “Competitor Ability” and “Health/Damage” (rated as 8, 6 and 7, respectively) but lower for “Reaction Speed” and “Multi-tasking” (rated as 3 and 2, respectively), may be chosen by a user who wishes for games to be relatively difficult in terms of the problems which must be solved, the ability of competitors and the amount of injury or damage which can be sustained but, due to finger dexterity restrictions, easier in terms of the required speed in reacting to events and multi-tasking using the controller 140.

In another example, a user may have excellent finger dexterity and reaction times but may find it difficult to concentrate on complex problems. In this case, they may wish to reduce the “Cognitive Complexity” difficulty rating (e.g. from 8 to 4 in FIG. 3) but increase the “Reaction Speed” difficulty rating (e.g. from 3 to 8 in FIG. 3).

An appropriate overall difficulty of the game can therefore be obtained by any user with particular needs or desires by fine tuning the difficulty associated with the individual gaming characteristics. It will be appreciated that the gaming characteristics exemplified in FIG. 3 are only examples and that the difficulty associated with different and/or additional gaming characteristics may be adjustable according to the present technique. It will also be appreciated that any number of (that is, one or more) gaming characteristics may be adjustable in this way.

The screen 300 also provides the user with the option of selecting or de-selecting “Adaptive Difficulty Adjustment” checkbox 314.

The selection of the checkbox 314 means that the selected difficulty ratings are applied based on one or more characteristics associated with a gaming ability of the user (that is, gaming ability characteristics of the user). This may be referred to as adaptive difficulty adjustment. This allows the relative difficulty experienced by users of different gaming ability to be similar for a given set of selected difficulty ratings, thereby helping to provide a more consistent gaming experience between users. This is explained in more detail below.

On the other hand, de-selection of the checkbox 314 means a user's gaming ability characteristic(s) are not taken into account when applying the selected difficulty ratings. The difficulty level in this case is therefore objectively the same for each user. This may be required, for example, if the game concerned is used for esports competitions and thus the difficulty needs to be objectively the same for all competitors.

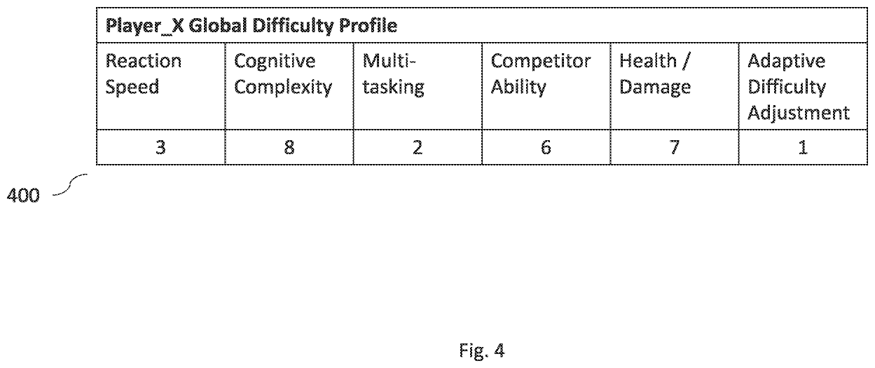

Once the user has provided the necessary inputs to select the difficulty rating of each gaming characteristic (e.g. via the screen 300) and to select or de-select the checkbox 314 (to activate or deactivate adaptive difficulty adjustment, respectively), they may save these settings by selecting the “Save” virtual button 313. This causes the information input via screen 300 to be stored. An example data structure 400 in which this information is stored is shown in FIG. 4.

The data structure 400 may be stored locally (e.g. in SSD 50) and/or remotely (e.g. by being transmitted to a server (not shown) over a network (not shown) via data port(s) 60). The stored data structure may also be associated with stored information indicative of a gaming profile uniquely associated with a particular player.

In this example, the data structure is associated with a player profile (gaming profile) identified by unique username “Player_X”. If the data structure is stored remotely with the information indicative of the “Player_X” gaming profile, then the data structure may be obtained by any device (e.g. other instances of games console 110) for which the storage location (e.g. server on a network) is accessible and on which the player associated with the “Player_X” gaming profile is logged in (this occurring via the “Player_X” username and a previously registered password, for example). This allows the difficulty settings of a particular player to be configured once via screen 300 and to then be automatically available in future sessions and/or on different devices on which the player is logged in, thereby providing improved user convenience and efficiency.

The data structure 400 indicates the unique username “Player_X” (thereby indicating the player profile to which it relates and which it should thus be associated with when stored) and that it is a “Global Difficulty Profile”. This information is also indicated as text 301 on screen 300 (as occurs, for example, if screen 300 is accessed on games console 110 when the player associated with the “Player_X” gaming profile is logged in). The data structure indicates the difficulty rating of each gaming characteristic configured via screen 300. It also indicates whether or not the “Adaptive Difficulty Adjustment” checkbox 314 has been selected. In this example, the checkbox 314 has been selected and therefore the data structure 400 indicates this is the case by indicating “1”. If the checkbox 314 had not been selected, then the data structure 400 may indicate this by indicating “0”. The selection or de-selection of the checkbox 314 may therefore be indicated by a single bit.

The data structure 400 represents a “Global Difficulty Profile” because the selected difficulty rating for each gaming characteristic indicated by the data structure is applicable to a plurality of different video games, as explained later. In addition, if the checkbox 314 has been selected to indicate that the selected difficulty ratings are to be applied based on a user's gaming ability characteristic(s), the user's gaming ability characteristic(s) are also determined.

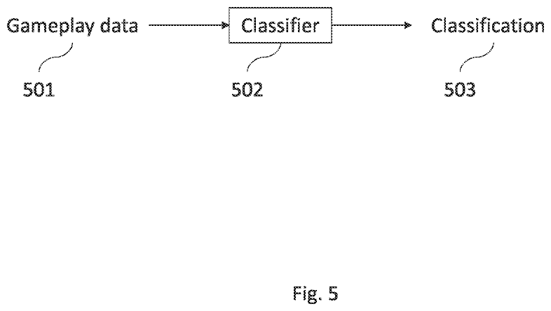

FIG. 5 shows one example technique for determining a user's gaming ability characteristic(s). Gameplay data 501 of the user is input to a classifier 502 (e.g. executed by the CPU 20 or by processing circuitry of a server (not shown) connected to the games console 110 over a network) to generate a classification indicative of the user's ability based on the gameplay data. This classification is an example of a gaming ability characteristic.

The gameplay data may be extracted from a plurality of different games played by the user (including, potentially, all games played by the user). For example, the gameplay data may indicate a value of each of one or more parameters applicable to any game played by the user, such as the rate (e.g. number of times per hour of gameplay) at which a game-ending event happens to the user (e.g. their character dies or a vehicle they are driving crashes irrecoverably), a highest score (e.g. normalised with respect to the highest achievable score) achieved by the user within a predetermined time period of previous gameplay (e.g. the last 3 hours of gameplay) and a proportion of a previous predetermined time period (e.g. the last 72 hours) during which the user was gaming.

The plurality of different games may be of different video game categories (e.g. racing game, first person shooter, action adventure, etc.) or of the same video game category (e.g. two or more different racing games, two or more different first person shooters, etc.). If the games are of the same category, the gameplay data parameter(s) may be more specific. For instance, for two different racing games, the parameter(s) may include the average finishing position of the user (e.g. 1^{st}, 2^{nd}, 3^{rd}, etc.) over a predetermined number (e.g. 5 or 10) of the previous races. For two different first person shooter games, the parameter(s) may include the proportion of shots by the user which successfully hit a target (e.g. an enemy character). This may help a user experience a consistent level of difficulty across different games in the same game category (so, for example, a user who has lots of experience with a first racing game title is less likely to be classified as a complete beginner if they then start playing a second racing game title).

Alternatively, or in addition, the gameplay data may be extracted from only a single game. In this case, the parameter(s) may be specific to that particular game. For instance, for a particular first person shooter where human players play against each other over a network, the parameter(s) may include an indication of the user's current ranking with respect to other players (the ranking being determined, for example, by proprietary algorithms associated with the specific game).

In an example, a classification determined for a particular category of games or for a single specific game is applied only to games of that category or for that single specific game, respectively. For other games, a classification determined for games of different categories may be used. This may include a classification based on gameplay data extracted from all games played by a particular user (which, as explained above, will be more general than gameplay data for specific games or game categories). The games console may be configured to use a plurality of different classifiers 502, such as a general classifier (for which gameplay data from all games played by the user is input), one or more category specific classifiers (for each of which gameplay data from all games of a particular category played by the user is input) and one or more game specific classifiers (for each of which gameplay data from a specific respective game played by the user is input).

The user may also be provided with an option (e.g. via suitable submenu(s) of screen 300) to override the difficulty rating associated with one or more of the gaming characteristics for a particular game or a particular category of games. This would allow the user, for example, to set the difficulty rating(s) to be higher in general but, for a particular game or category of games (e.g. racing games), set the difficulty rating(s) to be lower. This helps provide more flexibility to the user.

When gameplay data for a user from a plurality of different games is to be classified, the classifier 502 may be provided by the maker of the games console 110 (e.g. as part of an operating system of the games console or by a server (not shown) facilitating communication between different instances of games console 110 over a network). Alternatively, when gameplay data for a user from a single, specific, game is to be classified, the classifier 502 may be provided by the maker of the game (e.g. as part of the game application run on the games console 110 or by a server (not shown) facilitating network features of the game).

In an example, the classifier 502 is a trained machine learning classification model such as a logistic regression, K-Nearest Neighbours (KNN), Support Vector Machine (SVM), Kernel SVM, Naïve Bayes, decision tree, random forest or Artificial Neural Network (ANN) classification model. The model will have been previously trained to classify a particular user's ability based on one or more gameplay data parameters (such as those exemplified above) using appropriate training data.

To give an example, consider the example gameplay data parameters given above that may be associated with any of a plurality of different games of different categories (noting this is only an example and the present technique is not limited to this). These parameters are the rate (e.g. number of times per hour of gameplay) at which a game-ending event happens to the user, a highest score (e.g. normalised with respect to the highest achievable score) achieved by the user within a predetermined time period of previous gameplay (e.g. the last 3 hours of gameplay) and a proportion of a previous predetermined time period (e.g. the last 72 hours) during which the user was gaming.

The machine learning model of the classifier will be trained on training data comprising a suitable number of sets of these parameters and a labelled classification (e.g. as determined manually by a human) associated with each set.

For instance, the training data may include vectors of the format [X, Y, Z, C] where X=rate of game-ending events occurring, Y=highest score, Z=proportion of previous predetermined time period used for gaming and C=the classification. Here, X, Y and Z are the independent variables and C is the dependent variable. C takes one of a predetermined number of classifications indicating the ability of a user associated with the values of X, Y and Z. For instance, C may indicate the classification “Novice”, “Improver” and “Expert”.

The number and diversity of such vectors used for the training data is chosen to achieve suitable performance of the machine learning model. For example, 1000 such vectors may be obtained from a random sample of users who consent to the parameters X, Y and Z of their gameplay being recorded and classified by a human. 800 of those vectors may then be used as a training data set to train the machine learning model while the remaining 200 are used as a test data set to test the accuracy of the trained machine learning model. The machine learning model may be determined as trained when, once trained on the training data set, it is able to predict the classifications of the test data set with a certain degree of accuracy (e.g. 80% or more).

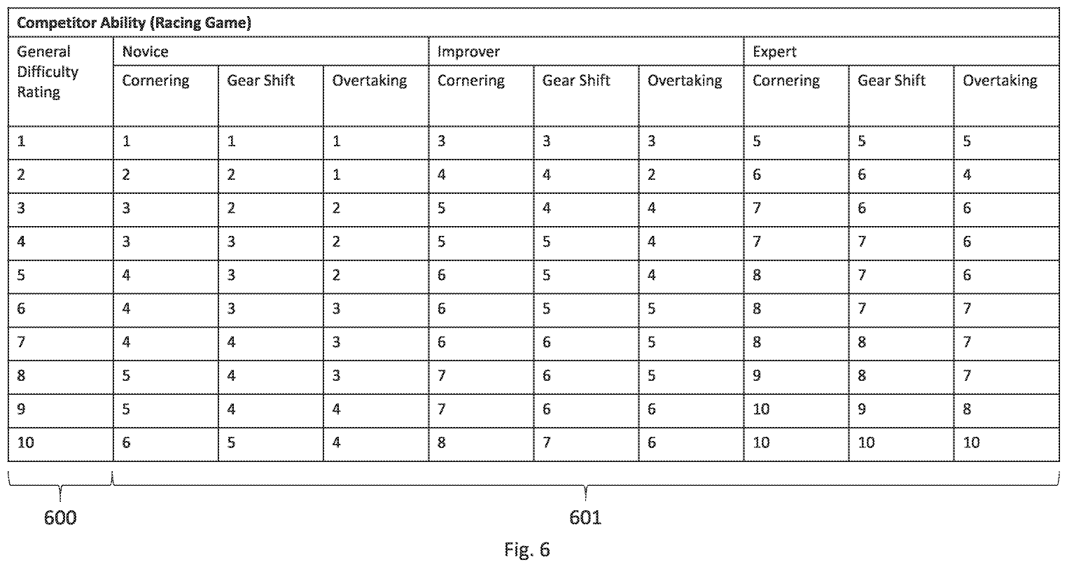

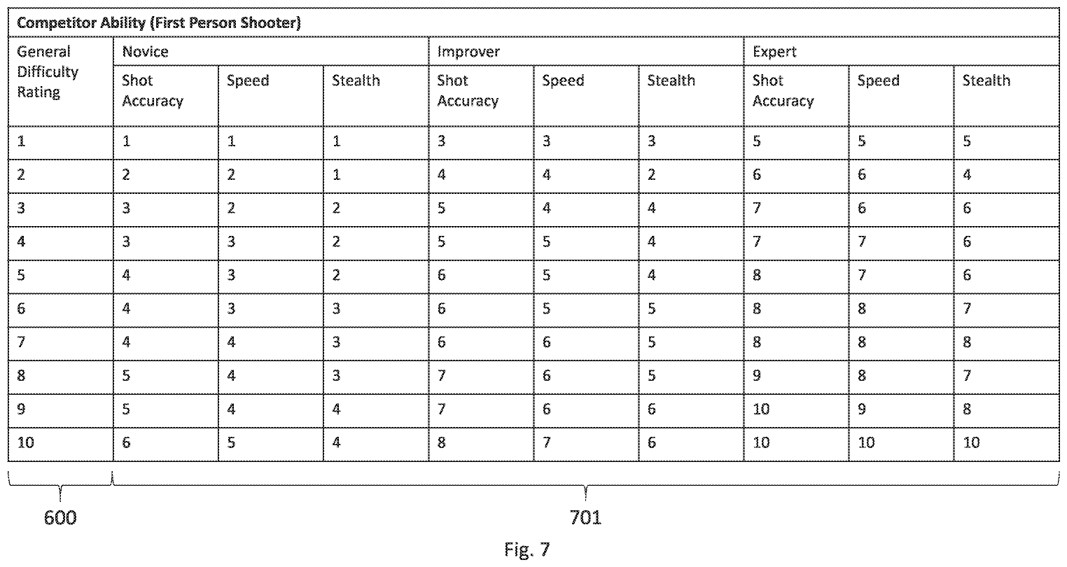

Once the machine learning model has been trained and is operating as the classifier 502, new data in the form [X, Y, Z] extracted from the gameplay of the current user may be input to the machine learning model to generate a classification. This classification may then be used, together with the data structure 400, to determine a level of difficulty which should be implemented for one or more gaming characteristics of the game the user is currently playing. This is exemplified in FIGS. 6 and 7.

Both FIGS. 6 and 7 relate to the “Competitor Ability” gaming characteristic defined in the data structure 400 and how it may be applied to different games while taking into account the ability classification of the user determined by the classifier 502.

FIG. 6 is a lookup table for a particular racing game (and is provided as part of the racing game application, for example). It relates the general difficulty rating of the “Competitor Ability” gaming characteristic (indicated in column 600) to respective specific difficulty ratings of gaming characteristics specific to this particular racing game for each ability classification (indicated in columns 601).

In this case, the specific gaming characteristics are the cornering ability of competitors (“Cornering”), the gear shift ability of competitors (“Gear Shift”) and the overtaking ability of competitors (“Overtaking”). Each of these has a specific difficulty rating which may range from 1 to 10, with 1 being easiest for the user (e.g. so competitors have poor cornering ability, slow gear shifts and an inability to overtake the user if they travel above a modest speed) and 10 being hardest for the user (e.g. so competitors have excellent cornering ability, quick gear shifts and are able to overtake the user even if they are travelling at high speed).

Thus, looking at data structure 400, it can be seen that the “Competitor Ability” general gaming characteristic has a general difficulty rating of 6. Looking at the lookup table of FIG. 6, for a player classified as a “Novice”, this corresponds to a “Cornering” difficulty rating of 4, a “Gear Shift” difficulty rating of 3 and an “Overtaking” difficulty rating of 3. For a player classified as an “Improver”, this corresponds to a “Cornering” difficulty rating of 6, a “Gear Shift” difficulty rating of 5 and an “Overtaking” difficulty rating of 5. For a player classified as an “Expert”, this corresponds to a “Cornering” difficulty rating of 8, a “Gear Shift” difficulty rating of 7 and an “Overtaking” difficulty rating of 7.

FIG. 7 is a lookup table for a particular first person shooter game (and is provided as part of the first person shooter game application, for example). It relates the general difficulty rating of the “Competitor Ability” gaming characteristic (again indicated in column 600) to respective specific difficulty ratings of gaming characteristics specific to this particular first person shooter game for each ability classification (indicated in columns 701).

In this case, the specific gaming characteristics are the shot accuracy of competitors (“Shot Accuracy”), the speed of competitors (“Speed”) and the ability of competitors to remain hidden through stealth tactics (“Stealth”). Each of these has a specific difficulty rating which may range from 1 to 10, with 1 being easiest for the user (e.g. so competitors have poor shot accuracy, are only able to move slowly and cannot easily move without being seen) and 10 being hardest for the user (e.g. so competitors have excellent shot accuracy, can move very quickly and are able to easily move over significant distances without being seen).

Thus, looking at data structure 400, it can be seen that the “Competitor Ability” general gaming characteristic has a general difficulty rating of 6. Looking at the lookup table of FIG. 7, for a player classified as a “Novice”, this corresponds to a “Shot Accuracy” difficulty rating of 4, a “Speed” difficulty rating of 3 and a “Stealth” difficulty rating of 3. For a player classified as an “Improver”, this corresponds to a “Shot Accuracy” difficulty rating of 6, a “Speed” difficulty rating of 5 and a “Stealth” difficulty rating of 5. For a player classified as an “Expert”, this corresponds to a “Shot Accuracy” difficulty rating of 8, a “Speed” difficulty rating of 8 and a “Stealth” difficulty rating of 7.

Although the lookup tables of FIGS. 6 and 7 relate specifically to the general gaming characteristic “Competitor Ability”, similar tables may be provided by makers of a particular game for each of the general gaming characteristics of the data structure 400.

For instance, for a racing game, the general gaming characteristic “Health/Damage” may be associated (via another suitable lookup table) with a specific gaming characteristic “Vehicle Damage” indicating the extent to which the performance of a vehicle may be curtailed in response to the vehicle suffering damage and the “Cognitive Complexity” general gaming characteristic may be associated (via another suitable lookup table) with a specific gaming characteristic “Track Complexity” indicating the length, number of corners, presence of obstacles, etc. of the racing track on which the vehicle travels

In another example, for a first person shooter, the general gaming characteristic “Health/Damage” may be associated (via another suitable lookup table) with a specific gaming characteristic “Character Health” indicating the extent to a player's character is injured following an attack by an enemy and the “Cognitive Complexity” general gaming characteristic may be associated (via another suitable lookup table) with a specific gaming characteristic “Map Complexity” indicating the size, number of routes, number of hiding places, etc. of the map on which the player's character moves around.

The present technique thus allows a user to adjust the general difficulty rating associated with one or more general gaming characteristics (e.g. those of the data structure 400, including “Reaction Speed”, “Cognitive Complexity”, etc.) via a single configuration operation (e.g. interaction with screen 300). This general difficulty rating may then be used by different games to automatically adjust the difficulty ratings of related specific gaming characteristics. The specific gaming characteristics are specific to those games. For example, “Cornering”, “Gear Shift” and “Overtaking” are specific gaming characteristics related to the general gaming characteristic “Competitor Ability” in the racing game of FIG. 6. On the other hand, “Shot Accuracy”, “Speed” and “Stealth” are specific gaming characteristics related to the general characteristic “Competitor Ability” in the first person shooter game of FIG. 7. Furthermore, if enabled by the user (e.g. by selecting the checkbox 314), the difficulty rating of each specific gaming characteristic may be automatically adjusted based on an ability of the user determined from the user's gameplay data.

An appropriate level of difficulty of any given game may therefore be automatically selected for a user with only a single initial difficulty configuration being required which is applicable to all games. This helps improve a user's gaming experience for different games while improving user convenience and reducing the time away from gameplay navigating configuration menus.

Furthermore, if the user does not wish even to undertake the single initial difficulty configuration (but wishes to start playing the game straightaway), a default difficult rating may be set (e.g. by the maker of the games console 110) for each of the general gaming characteristics (for example, the default difficulty rating of each of the general gaming characteristics of FIG. 3 may be set as “5”). The difficulty level may then still be adjusted automatically in the ways described.

In an example, the data structure 400 may be updated any time by a user once again accessing the global difficulty profile selection screen 300, making any necessary adjustments and selecting the “Save” virtual button 313.

The data structure 400 is stored and made available to game applications so that the difficulty rating of specific gaming characteristics associated with those game applications may be dynamically adjusted in the way described. Similarly, if the classifier 502 is provided by the maker of the games console 110 (e.g. as part of an operating system of the games console or by a server (not shown) facilitating communication between different instances of games console 110 over a network), at least the output (that is, classification 503) of the classifier is also made available to those game applications.

In an example, if a user does not select adaptive difficulty adjustment (e.g. by de-selecting checkbox 314), a particular set of default difficulty rating(s) for the specific gaming characteristic(s) related to each general gaming characteristic may be applied. These difficulty rating(s) may be indicated as additional value(s) in the relevant lookup table. Alternatively, the difficult rating(s) already associated with a particular classification (e.g. the “Improver” classification in FIGS. 6 and 7) may be set as the default difficulty rating(s), thereby alleviating the need for additional value(s) in the relevant lookup table (and thus reducing the lookup table data size).

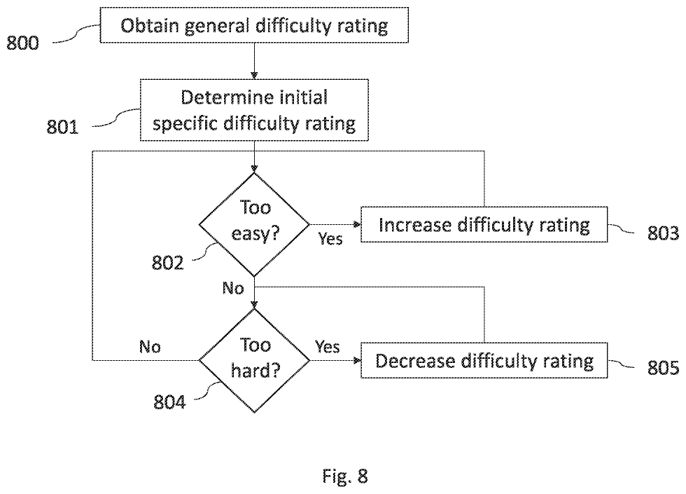

Instead of, or in addition to, the use of classifier 502, the determined difficulty rating of a specific gaming characteristic may be dynamically adjusted as the user plays the game so that, for example, one or more parameters indicative of the user's performance each remain at a particular value or within a particular range. This functionality may again be enabled when adaptive difficulty adjustment is selected and helps to further tune the level of difficulty experienced by a user in a game to the ability of that user, thereby improving the user's enjoyment of and engagement with the game. Such functionality is exemplified in FIG. 8 and is implemented, for example, by CPU 20 or by processing circuitry of a server (not shown) connected to the games console 110 over a network.

At step 800, a general difficulty rating is obtained. This is associated with a general gaming characteristic. Thus, for example, to use again the example of data structure 400, the general gaming characteristic may be “Competitor Ability” and general difficulty rating obtained at step 800 may be 6.

At step 801, the obtained general difficulty rating is used to determine an initial difficulty rating of a specific gaming characteristic associated with the general gaming characteristic. Thus, using the example of FIG. 6, the specific gaming characteristic may be “Cornering”, “Gear Shift” or “Overtaking” and using the example of FIG. 7, the specific gaming characteristic may be “Shot Accuracy”, “Speed” and “Stealth”.

To illustrate this, consider the specific gaming characteristic “Shot Accuracy” for a user classified with “Improver” ability playing the first person shooter game of FIG. 7. According to FIG. 7, the specific difficulty rating for this user for “Shot Accuracy” when the selected general difficulty rating for “Competitor Ability” is 6 is also 6. The specific difficulty rating “6” for “Shot Accuracy” is therefore determined at step 801.

At step 802, it is determined whether the specific difficulty rating “6” for “Shot Accuracy” is too easy. This may be determined by measuring a parameter indicative of the user's performance over a predetermined time period and comparing it with a reference value or reference range.

For example, the parameter may be the number of times the user's character is shot and killed by an enemy player in a given time period (e.g. the number of times the character has died in the previous hour of gameplay). A lower acceptable limit of the parameter (e.g. 5 deaths per hour) and an upper acceptable limit of the parameter (e.g. 10 deaths per hour) is set in advance (e.g. by the game application).

The specific difficulty rating “6” for “Shot Accuracy” is considered to be too easy if the player is determined to have fallen below the lower acceptable limit. In this case, the specific difficulty level is increased at step 803. For example, the “Shot Accuracy” rating may be increased from 6 to 7. The process then returns to step 802.

If the player is determined not to have fallen below the lower acceptable limit at step 802, the process proceeds to step 804. At step 804, it is determined whether the specific difficulty rating “6” for “Shot Accuracy” is too hard. It is considered to be too hard if the player is determined to have exceeded the upper acceptable limit. In this case, the specific difficulty level is decreased at step 805. For example, the “Shot Accuracy” rating may be decreased from 6 to 5. The process then returns to step 804.

If the player is determined not to have exceeded the upper acceptable limit at step 804, the process returns to step 802.

In this way, the specific difficulty rating of a given specific gaming characteristic can be fine-tuned based on a user's real time performance in a game. It will be appreciated that this may be applied to any specific gaming characteristic(s) associated with each of one or more of the general gaming characteristics through the measurement of an appropriate parameter indicative of the user's performance. For instance, another example parameter may be an indication of whether or not a user has been able to complete a particular level of a game given a predetermined number of attempts (e.g. 5 attempts). If the user exceeds the predetermined number of attempts without success, it is determined the game is too hard and the difficulty rating is reduced. On the other hand, if the user completes the level in less than the predetermined number of attempts, it is determined the game is too easy and the difficulty rating is increased.

The principles exemplified by FIG. 8 may be applied in combination with the determination of a user's ability classification. In this case, the user's ability classification enables the initial specific difficulty rating to be determined based on this classification at step 801. This may help a suitable specific difficulty rating to be obtained more quickly (since the initial value is likely to better reflect the ability of the user from the outset).

Alternatively, the principles exemplified by FIG. 8 may be applied without using a user's ability classification. In this case, the initial specific difficulty rating determined at step 801 is the same for all users (e.g. it is set as a predefined default value). The specific difficulty rating is then adjusted based on increases (e.g. step 803) and/or decreases (e.g. step 805) until the level of difficulty experienced is deemed appropriate (e.g. based on a parameter indicative of the user's performance matching a predetermined reference value or falling within a predetermined reference range, such as the range defined by the lower acceptable limit (e.g. step 802) and upper acceptable limit (e.g. step 804) of FIG. 8). This improves the ability of a game developer to enable dynamic difficulty adjustment of a game based on the difficulty ratings for various general gaming characteristics set by a user (e.g. using screen 300) even if they do not wish or are not able to user a suitable classifier 502. Developer flexibility is therefore improved.

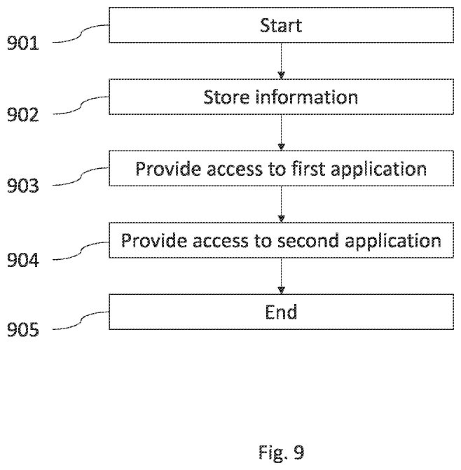

A data processing method according to the present technique is shown in FIG. 9. The method is a computer-implemented method carried out by circuitry of a data processing apparatus (e.g. the CPU 20 of games console 110 and/or processing circuitry of a server (not shown) connected to the games console 110 over a network, such as via data port(s) 60). The method starts at step 901.

At step 902, information (e.g. data structure 400) indicative of a general difficulty rating associated with each of one or more general gaming characteristics (e.g. “Reaction Speed”, “Cognitive Complexity”, etc. in FIG. 3) applicable to a plurality of video games is stored (e.g. in SSD 50 or in a storage medium of a server (not shown) connected to the games console 110 over a network, such as via data port(s) 60).

At step 903, access to the stored information is provided to an application (e.g. executed by the CPU 20) of a first video game (e.g. a racing game) to enable a specific difficulty rating associated with a specific gaming characteristic applicable to the first video game to be determined based on each general difficulty rating (for example, determining a specific difficulty rating of the specific gaming characteristics “Cornering”, “Gear Shift” and/or “Overtaking” based on the general difficulty rating of the general gaming characteristic “Competitor Ability”, as exemplified in FIG. 6).

At step 904, access to the stored information is provided to an application (e.g. executed by the CPU 20) of a second video game (e.g. a first person shooter) to enable a specific difficulty rating associated with a specific gaming characteristic applicable to the second video game to be determined based on each general difficulty rating (for example, determining a specific difficulty rating of the specific gaming characteristics “Shot Accuracy”, “Speed” and/or “Stealth” based on the general difficulty rating of the general gaming characteristic “Competitor Ability”, as exemplified in FIG. 7). The method ends at step 905.

Example(s) of the present technique are defined by the following numbered clauses:

1. A data processing apparatus comprising circuitry configured to: store information indicative of a general difficulty rating associated with each of one or more general gaming characteristics applicable to a plurality of video games; provide access to the stored information to an application of a first video game to enable a specific difficulty rating associated with a specific gaming characteristic applicable to the first video game to be determined based on each general difficulty rating; and provide access to the stored information to an application of a second video game to enable a specific difficulty rating associated with a specific gaming characteristic applicable to the second video game to be determined based on each general difficulty rating.

2. A data processing apparatus according to clause 1, wherein the one or more general gaming characteristics comprise one or more of: an indication of a reaction speed required by a user in responding to stimuli in a video game, an indication of a complexity of a problem a user must solve in a video game; an indication of a number of simultaneous tasks a user must perform in a video game; an indication of an ability of a competitor in a video game; and an indication of a capacity of an in-game character or object controlled by a user to sustain injury or damage.

3. A data processing apparatus according to any preceding clause, wherein the circuitry is configured to receive an input from a user selecting a general difficulty rating associated with each of the one or more general gaming.

4. A data processing apparatus according to clause 3, wherein the information indicative of the general difficulty rating associated with each of one or more general gaming characteristics is stored in association with a gaming profile of the user.

5. A data processing apparatus according to any preceding clause, wherein the circuitry is configured to: receive gameplay data generated by a user playing the first video game; and adjust, using the gameplay data, a specific difficulty rating associated with a specific gaming characteristic applicable to the second video game.

6. A data processing apparatus according to clause 4, wherein the circuitry is configured to: determine, using the gameplay data, a classification of the user indicative of a gaming ability of the user; and adjust the specific difficulty rating associated with the specific gaming characteristic applicable to the second video game using the determined classification.

7. A data processing apparatus according to clause 6, wherein: the first and second video games are of a same video game category; and the classification of the user is applicable to video games of the same video game category.

8. A data processing apparatus according to clause 6, wherein: the first and second video games are of different respective video game categories; and the classification of the user is applicable to video games of the different video game categories.

9. A data processing apparatus according to any one of clauses 5 to 8, wherein the circuitry is configured to receive an input from a user activating or deactivating the adjustment of the specific difficulty rating associated with the specific gaming characteristic applicable to the second video game.

10. A data processing method comprising: storing information indicative of a general difficulty rating associated with each of one or more general gaming characteristics applicable to a plurality of video games; providing access to the stored information to an application of a first video game to enable a specific difficulty rating associated with a specific gaming characteristic applicable to the first video game to be determined based on each general difficulty rating; and providing access to the stored information to an application of a second video game to enable a specific difficulty rating associated with a specific gaming characteristic applicable to the second video game to be determined based on each general difficulty rating.

11. A program for controlling a computer to perform a method according to clause 10.

12. A storage medium storing a program according to clause 11.

Numerous modifications and variations of the present disclosure are possible in light of the above teachings. It is therefore to be understood that, within the scope of the claims, the disclosure may be practiced otherwise than as specifically described herein.

In so far as embodiments of the disclosure have been described as being implemented, at least in part, by one or more software-controlled information processing apparatuses, it will be appreciated that a machine-readable medium (in particular, a non-transitory machine-readable medium) carrying such software, such as an optical disk, a magnetic disk, semiconductor memory or the like, is also considered to represent an embodiment of the present disclosure. In particular, the present disclosure should be understood to include a non-transitory storage medium comprising code components which cause a computer to perform any of the disclosed method(s).

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more computer processors (e.g. data processors and/or digital signal processors). The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to these embodiments. Additionally, although a feature may appear to be described in connection with particular embodiments, one skilled in the art would recognize that various features of the described embodiments may be combined in any manner suitable to implement the present disclosure.

1. A data processing apparatus comprising circuitry configured to:
store information indicative of a general difficulty rating associated with each of one or more general gaming characteristics applicable to a plurality of video games;
provide access to the stored information to an application of a first video game to enable a specific difficulty rating associated with a specific gaming characteristic applicable to the first video game to be determined based on each general difficulty rating; and
provide access to the stored information to an application of a second video game to enable a specific difficulty rating associated with a specific gaming characteristic applicable to the second video game to be determined based on each general difficulty rating.

2. A data processing apparatus according to claim 1, wherein the one or more general gaming characteristics comprise one or more of:
an indication of a reaction speed required by a user in responding to stimuli in a video game,
an indication of a complexity of a problem a user must solve in a video game;
an indication of a number of simultaneous tasks a user must perform in a video game;
an indication of an ability of a competitor in a video game; and
an indication of a capacity of an in-game character or object controlled by a user to sustain injury or damage.

3. A data processing apparatus according to claim 1, wherein the circuitry is configured to receive an input from a user selecting a general difficulty rating associated with each of the one or more general gaming.

4. A data processing apparatus according to claim 3, wherein the information indicative of the general difficulty rating associated with each of one or more general gaming characteristics is stored in association with a gaming profile of the user.

5. A data processing apparatus according to claim 1, wherein the circuitry is configured to:
receive gameplay data generated by a user playing the first video game; and
adjust, using the gameplay data, a specific difficulty rating associated with a specific gaming characteristic applicable to the second video game.

6. A data processing apparatus according to claim 4, wherein the circuitry is configured to:
determine, using the gameplay data, a classification of the user indicative of a gaming ability of the user; and
adjust the specific difficulty rating associated with the specific gaming characteristic applicable to the second video game using the determined classification.

7. A data processing apparatus according to claim 6, wherein:
the first and second video games are of a same video game category; and
the classification of the user is applicable to video games of the same video game category.

8. A data processing apparatus according to claim 6, wherein:
the first and second video games are of different respective video game categories; and
the classification of the user is applicable to video games of the different video game categories.

9. A data processing apparatus according to claim 5, wherein the circuitry is configured to receive an input from a user activating or deactivating the adjustment of the specific difficulty rating associated with the specific gaming characteristic applicable to the second video game.

10. A data processing method comprising:
storing information indicative of a general difficulty rating associated with each of one or more general gaming characteristics applicable to a plurality of video games;
providing access to the stored information to an application of a first video game to enable a specific difficulty rating associated with a specific gaming characteristic applicable to the first video game to be determined based on each general difficulty rating; and
providing access to the stored information to an application of a second video game to enable a specific difficulty rating associated with a specific gaming characteristic applicable to the second video game to be determined based on each general difficulty rating.

11. (canceled)

12. A non-transitory computer-readable storage medium storing a program for controlling a computer to perform a method comprising:
storing information indicative of a general difficulty rating associated with each of one or more general gaming characteristics applicable to a plurality of video games;
providing access to the stored information to an application of a first video game to enable a specific difficulty rating associated with a specific gaming characteristic applicable to the first video game to be determined based on each general difficulty rating; and
providing access to the stored information to an application of a second video game to enable a specific difficulty rating associated with a specific gaming characteristic applicable to the second video game to be determined based on each general difficulty rating.
